(19) United States
(12) Patent Application Publication
(10) Pub. No.: US 2020/0277121 A1
(43) Pub. Date: Sep. 3, 2020

(54) SEALING COVER HAVING OPENING TAP FOR CONTAINERS AND METHOD FOR MANUFACTURING THE SAME

(71) Applicant: SEAL AND PACK CO., LTD., Icheon-si (KR)

(72) Inventor: Se-Hwang WEI, Yongin-si (KR)

(21) Appl. No.: 16/876,141

(22) Filed: May 18, 2020

Related U.S. Application Data
(63) Continuation-in-part of application No. 14/222,970, filed on Mar. 24, 2014.

(30) Foreign Application Priority Data
Jan. 15, 2014 (KR) 10-2014-0005010

(51) Int. Cl. B65D 77/20; B65D 53/04; B32B 7/12; B32B 27/36; B32B 27/32; B32B 15/08; B32B 15/20

(52) U.S. Cl. CPC B65D 77/2056; B65D 53/04; B32B 7/12; B32B 27/36; B32B 2435/02; B32B 15/08; B32B 15/20; B65D 2577/205; B32B 27/32

(57) ABSTRACT

A sealing cover includes a tab-forming layer, an intermediate substrate layer, and a sealing layer. The tab-forming layer includes a surface layer, a first adhesive layer under the surface layer, a folded layer under the first adhesive layer, and a second adhesive layer under the first adhesive layer and the folded layer. The intermediate substrate layer is formed under the tab-forming layer. The sealing layer is formed under the intermediate substrate layer. The folded layer includes an upper portion and a lower portion branched from one end of the folded layer, forming an opening tab.

### CROSS-REFERENCE TO RELATED APPLICATION(S)

This U.S. Non-provisional Patent Application is a continuation-in-part of U.S. patent application Ser. No. 14/222,970, filed on Mar. 24, 2014, which claims priority under 35 U.S.C. 119 to Korean Patent Application No. 10-2014-0005010, filed on Jan. 15, 2014, in the Korean Intellectual Property Office, the disclosures of which are herein incorporated by reference in their entireties.

### TECHNICAL FIELD

The disclosure relates generally to sealing covers having opening tabs for containers and, more particularly, to a sealing cover for containers which has an increased adhesive area between an opening tab and the sealing cover so that a user can easily remove the sealing cover from a container, and a method for manufacturing the sealing cover.

### DISCUSSION OF RELATED ART

Different kinds of sealing covers are used to seal apertures of containers.

Such sealing covers for containers have several functions such as a function of protecting the contents of a container, an easy-opening function, etc. The functions of the sealing covers also continue to evolve for the sake of consumer convenience.

Recently, high-frequency induction heating is mainly used to seal the aperture of a container with a sealing cover, whereby the sealability of the sealing cover can be enhanced.

In the high-frequency induction heating method, the sealing cover is disposed in a cap of the container before the container is coupled to the contents-filled container. Subsequently, the sealing cover adheres, through high-frequency induction heating, to a portion of the container that defines an aperture thereof.

However, in the above method, because the shape and size of the sealing cover that adheres to the container to seal the aperture are the same as those of the portion of the container that defines the aperture thereof, it is inconvenient for a user to remove the sealing cover from the container.

In an effort to overcome the above problem, several improved structures have been introduced. For example, there is a structure in which a tab protrudes outwards from a peripheral edge of the sealing cover, and a structure in which a semi-circular tab is provided on an upper surface of a sealing cover.

Particularly, as examples of the sealing cover having the semi-circular tab, products of Stanpac Inc. of Canada have been widely used and are being widely used.

However, the conventional sealing cover having the semi-circular tab is configured in such a way that an upper layer and a lower layer of the sealing cover adhere to each other only in a remaining semi-circular area of the sealing cover that is other than the tab. Therefore, if the strength with which the sealing cover adheres to the container is comparatively high, when a user grasps the semi-circular tab and pulls it to remove the sealing cover form the container, only the tab and a portion around the tab may be detached from the sealing cover rather than the entirety of the sealing cover being removed from the container. Moreover, there is a disadvantage in that, because of the problem, the size of the tab is limited.

FIGS. 1A and 1B illustrate a conventional sealing cover.

FIG. 1A shows a circular sealing cover 30 which is provided with at least one small tab 30a formed on a circumferential edge thereof so that a consumer can use the tab 30a to open a container 10.

FIG. 1B shows a sealing cover 30 in which a polyester film layer 32 is formed on an upper surface of the sealing cover 30, wherein only a half of the polyester film layer 32 adheres to the sealing cover 30, and the other half thereof is used as an opening tab 32a. When a consumer grasps the semi-circular opening tab 32a and pulls it in the y-axis direction, the sealing cover 30 is removed from the container 10.

Particularly, the construction of the sealing cover (30; 32, 34) of FIG. 1B will be explained in detail below. The sealing cover 30 includes an upper layer 32 which is formed of a polyester film, and a lower layer 34 which adheres to a lower surface of the upper layer 32.

After an adhesive is applied to the lower surface of the polyester film that is the upper layer 32, a band-shaped film 36 or paper is interposed between the upper and lower layers 32 and 34 and bonded to the upper layer 32, and then the lower layer 34 adheres to the upper layer 32. Here, while an upper surface of the band-shaped film 36 first adheres to the upper layer 32, a lower surface of the band-shaped film 36 does not adhere to the lower layer 34. The portion of the upper layer 32 that does not adhere to the lower layer 34 due to the band-shaped film 36 forms the opening tab 32a.

However, in this conventional technique, because only a half portion of the upper layer 32 that has a circular shape adheres to the lower layer 34, the adhesive strength therebetween is not sufficient. Furthermore, if the strength with which the sealing cover 30 adheres to the container 10 is comparatively high, when the opening tab 32a is pulled, only the opening tab 32a may be separated from the sealing cover 30 rather than the sealing cover 30 being removed from the container 10.

In other words, when the tab 32a is pulled in the y-axis direction, as shown in the right view of FIG. 2, a phenomenon of only the tab 32a being delaminated may be induced.

Meanwhile, in the case of a small sized sealing cover, as shown in FIG. 3, the opening tab 32a provided on the upper layer 32 may have almost circular shape, rather than having a semi-circular shape, so as to allow a user to easily grasp the opening tab 32a. In this case, the adhesive area between the polyester film that is the upper layer 32 and the lower layer 34 is further reduced. As a result, the delamination phenomenon is more easily caused.

### SUMMARY

According to an embodiment, a sealing cover for containers in which the whole area of an upper layer provided with an opening tab substantially adheres to the lower layer with sufficient adhesive strength. The sealing cover can be easily and reliably removed from a container regardless of whether the opening tab has a semi-circular shape or a circular shape.

According to an embodiment, there is provided a method for manufacturing the sealing cover.

According to an embodiment, a sealing cover having an opening tab for a container includes a tab-forming layer provided with the opening tab and a sealing layer formed under the tab-forming layer. The sealing layer has a function of substantially sealing the container.

The sealing cover may further include an intermediate substrate layer interposed between the tab-forming layer and the sealing layer. The intermediate substrate layer provides a close contact function and a shock absorbing function when a cap is coupled to the container.

The sealing layer may include an aluminum foil layer isolating an interior of the container from an exterior thereof, the aluminum foil layer generating heat through high-frequency induction heating and a heat-sealing resin layer provided under the aluminum foil layer. The heat-sealing resin layer may be adhered to the container by heat generated from the aluminum foil layer.

A thickness of the aluminum foil layer may range from 0.009 mm to 0.05 mm.

The heat-sealing resin layer may be made of one among polyolefin, EVA (ethylene vinyl acetate), EMA (ethylene methacrylic acid) and ionomer depending on a material of the container so as to provide an easy peel seal function.

A thickness of the heat-sealing resin layer may range from 0.03 mm to 0.1 mm.

The heat-sealing resin layer may include a film produced by a blown film method or is formed by an extrusion coating method.

A lower surface of the intermediate substrate layer and the aluminum foil layer provided in an upper portion of the sealing layer may be adhered to each other by a dry lamination method using a solvent-based urethane adhesive or by an extrusion lamination method of melting a raw material containing polyethylene, EVA (ethylene vinyl acetate) or EMAA (ethylene-methacrylic acid-acrylate) and extrusion-laminating.

The tab-forming layer may include a surface layer formed of a PET (polyethylene terephthalate) or PP (polypropylene) film having no heat adhesive property, the surface layer having a thickness ranging from 0.012 mm to 0.05 mm, an inner or outer surface of the surface layer being printed by a gravure process, a first heat-adhesive resin layer formed under a lower surface of the surface layer, a folded film layer provided under a lower surface of the first heat-adhesive resin layer so as to form the opening tab, the folded film layer having a thickness ranging from 0.012 mm to 0.05 mm and being made of a PET (polyethylene terephthalate) or PP (polypropylene) film having no heat adhesive property, the folded film layer having a band shape formed in such a way that the PET or PP film folds double; and a second heat-adhesive resin layer adhering both to a lower surface of the folded film layer and to the first heat-adhesive resin layer that is exposed to an area other than the folded film layer.

The folded film layer may form the opening tab using a structure in which when the folded film layer is cut into a size capable of being inserted into a cap, inner surfaces of the folded film layer that face each other do not adhere to each other.

The folded film layer may be folded double on one side or both sides thereof.

The folded film layer may be folded double in such a way that a cylindrical film roll is pressed to be flat.

The first heat-adhesive resin layer and the second heat-adhesive resin layer may be formed by an extrusion lamination method and are made of any one among EVA (ethylene vinyl acetate), EMAA (ethylene-methacrylic acid-acrylate) and polyolefin-based adhesive resin containing polyethylene.

The first heat-adhesive resin layer and the second heat-adhesive resin layer may be made of ethylene-methacrylic acid-acrylate terpolymer resin which is produced by DuPont Inc. and sold in a brand name “Nucrel” that is able to adhere to the PET or PP film without conducting a separate chemical primer process.

In another aspect, the disclosure provides a method for manufacturing a sealing cover for a container, the sealing cover including: a tab-forming layer provided with an opening tab; and a sealing layer formed under the tab-forming layer, the sealing layer having a function of substantially sealing the container, the method including: preparing a folded film layer formed by folding a PET (polyethylene terephthalate) or PP (polypropylene) film double, the PET or PP film having no heat adhesive property and having a thickness ranging from 0.012 mm to 0.05 mm; preparing a surface layer made of a PET or PP film having no heat adhesive property, the surface layer having a thickness ranging from 0.012 mm to 0.05 mm, an inner or outer surface of the surface layer being printed by a gravure method; preparing a sealing layer to be adhered to the container to isolate an interior of the container from an exterior thereof; a first adhesion operation of adhering the surface layer to an upper surface of the folded film layer using a first heat-adhesive resin layer; a second adhesion operation, using a second heat-adhesive resin layer, of adhering the sealing layer both to a lower surface of the folded film layer and to a portion of the first heat-adhesive resin layer that is other than the lower surface of the folded film layer; and cutting an output of the second adhesion operation such that a portion of a side of the folded film layer is removed, and forming the opening tab using a portion of the folded film layer.

The first heat-adhesive resin layer may be formed by an extrusion lamination method of melting adhesive resin and extrusion-adhering the surface layer to the folded film layer.

The second heat-adhesive resin layer may be formed by an extrusion lamination method of melting adhesive resin equal to the adhesive resin forming the first heat-adhesive resin layer and extrusion-adhering the sealing layer both to the lower surface of the folded film layer and to the portion of the first heat-adhesive resin layer that is other than the lower surface of the folded film layer.

The folded film may form the opening tab using a structure in which when the folded film layer is cut into a size capable of being inserted into a cap, inner surfaces of the folded film layer that face each other do not adhere to each other.

The folded film layer may be folded double on one side or both sides thereof

The folded film layer may be folded double in such a way that a cylindrical film roll is pressed to be flat.

The first heat-adhesive resin layer and the second heat-adhesive resin layer may be made of any one among EVA (ethylene vinyl acetate), EMAA (ethylene-methacrylic acid-acrylate) and polyolefin-based adhesive resin containing polyethylene.

The first heat-adhesive resin layer and the second heat-adhesive resin layer may be made of ethylene-methacrylic acid-acrylate terpolymer resin which is produced by DuPont Inc. and sold in a brand name “Nucrel” that is able to adhere to the PET or PP film without conducting a separate chemical primer process.

According to an embodiment, a sealing cover includes a tab-forming layer, an intermediate substrate layer, and a sealing layer. The tab-forming layer includes a surface layer, a first adhesive layer under the surface layer, a folded layer under the first adhesive layer, and a second adhesive layer under the first adhesive layer and the folded layer. The intermediate substrate layer is formed under the tab-forming layer. The sealing layer is formed under the intermediate substrate layer. The folded layer includes an upper portion and a lower portion branched from one end of the folded layer, forming an opening tab.

The folded layer may include a folded PE film and a folded urethane layer surrounding the PE film. The urethane layer of the folded layer may be attached to the first adhesive layer and the second adhesive layer.

The folded layer may be folded substantially in a shape of “<.”

When the container is a bottle, the sealing cover may be sized or shaped to correspond to a mouth of the bottle.

The surface layer and the folded layer may be formed of substantially the same material, and the first adhesive layer and the second adhesive layer may be formed of substantially the same material but different from, but strongly bonded to, the surface layer and the folded layer.

In a sealing cover for containers according to the disclosure, an opening tab which is provided on an upper surface of the sealing cover can not only have a semi-circular shape but can also have an almost circular shape. Therefore, a consumer can more conveniently and easily open the container.

Furthermore, with regard to adhesion between layers that forms the opening tab, unlike the conventional technique, in the sealing cover according to the disclosure, because the whole area of an upper layer that forms the opening tab substantially adhere to a lower layer, a delamination phenomenon in which only the opening tab is removed from the sealing cover when the container is opened can be prevented. Therefore, the disclosure can provide the container sealing cover that has a more reliable structure.

### BRIEF DESCRIPTION OF THE DRAWINGS

The above and other objects, features and advantages of the disclosure will be more clearly understood from the following detailed description taken in conjunction with the accompanying drawings, in which:

FIGS. 1A and 1B show a conventional sealing cover in a closed (FIG. 2A) and open (FIG. 2B) arrangement, respectively;

FIG. 2 shows a delamination phenomenon of the conventional sealing cover in which only an opening tab is removed therefrom;

FIG. 3A and 3B, respectively, are a plan view and side elevation view of an opening tab of a conventional sealing cover;

FIG. 4 is a perspective view illustrating a container provided with a sealing cover according to an embodiment of the disclosure;

FIGS. 5A and 5B illustrate a method of removing the sealing cover from the container, according to an embodiment of the disclosure;

FIG. 6 is a view illustrating the construction of the sealing cover according to an embodiment of the disclosure;

FIGS. 7A, 7B, 7C, 8A, 8B, and 8C are views illustrating a method for manufacturing the sealing cover according to an embodiment of the disclosure;

FIGS. 9A and 9B are views schematically illustrating a method of cutting out the sealing cover according to an embodiment of the disclosure;

FIG. 10A is a view illustrating a folded film layer included in a sealing cover according to an embodiment of the disclosure;

FIG. 10B is a view illustrating an arrangement of a surface layer, a first heat-adhesive resin layer, and a folded film layer included in a sealing cover according to an embodiment;

FIG. 10C is a view illustrating an arrangement of a tab-forming layer, an intermediate substrate layer, and a sealing layer included in a sealing cover according to an embodiment of the disclosure;

FIG. 10D is a view illustrating a layered structure of a sealing cover according to an embodiment of the disclosure;

FIG. 10E is a view illustrating an example operation of a sealing cover according to an embodiment of the disclosure;

FIG. 10F is a view illustrating how attaching force works between the folded film layer and the layers on the side and bottom of the folded film layer the upon pulling the opening tab upwards as shown in FIG. 10E;

FIG. 11A is a view illustrating a folded film layer included in a sealing cover according to an embodiment of the disclosure;

FIG. 11B is a view illustrating an arrangement of a surface layer, a first heat-adhesive resin layer, and a folded film layer included in a sealing cover according to an embodiment;

FIGS. 11C and 11D are views illustrating an example of arranging and attaching together a tab-forming layer, an intermediate substrate layer, and a sealing layer included in a sealing cover according to an embodiment of the disclosure;

FIGS. 11E, 11F, and 11G are views illustrating an example of gradually lifting up the opening tab formed by cutting the layered structure of FIG. 11D off, at the middle thereof;

FIG. 11H is a view illustrating an example of pulling up a the sealing cover attached to the mouth of the container;

FIG. 11I is a view illustrating the attaching force applied to the opening tab when the sealing cover is pulled up from the container;

FIGS. 12A, 12B, and 12C are views illustrating a process for manufacturing an opening tab by cutting a layered structure for a sealing cover, along lines denoted with B′ and B″, according to an embodiment of the disclosure;

FIGS. 12D and 12E are views illustrating an example in which the opening tab formed as shown in FIG. 12C is gradually lifted up;

FIG. 12F is a view illustrating an example in which the sealing cover attached to the container is pulled up and removed from the container by applying force;

FIG. 12G is a view illustrating attaching force works in directions denoted with arrows between some components of a sealing cover when the opening tab is pulled up from the container;

FIG. 13A is a perspective view illustrating an example in which a sealing cover is attached to a container according to an embodiment of the disclosure;

FIG. 13B is a perspective view illustrating an example in which the sealing cover of FIG. 13A is removed from the container by pulling up with the opening tab;

FIG. 13C illustrates a position where an opening tab according to the disclosure is positioned on the mouth of a container; and

FIG. 13D illustrates attaching force working in directions denoted with arrows between some components of a sealing cover according to an embodiment of the disclosure.

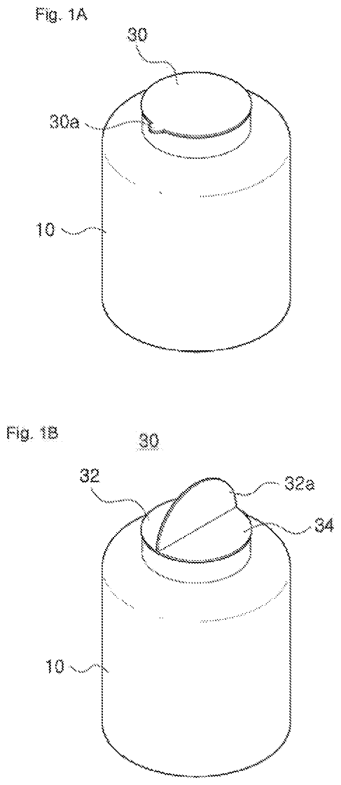

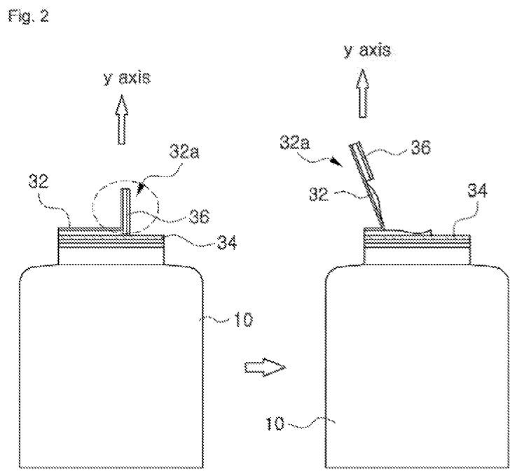

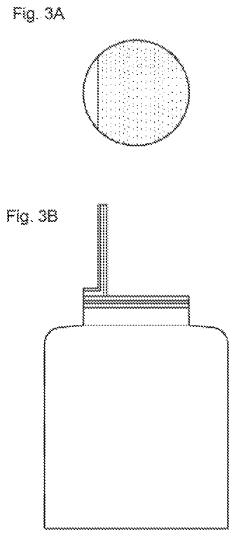

### DETAILED DESCRIPTION OF EXEMPLARY EMBODIMENTS

Hereinafter, embodiments of the disclosure are described in detail with reference to the attached drawings.

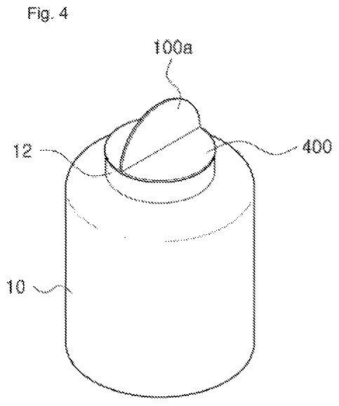

FIG. 4 is a perspective view illustrating a container provided with a container sealing cover (hereinafter, referred to as a sealing cover 400) according to an embodiment of the disclosure.

Referring to FIG. 4, the sealing cover 400 according to the disclosure has an opening tab 100a at the top. An aperture 12 (also referred to herein as a mouth) of the container 10 is sealed with the sealing cover 400. Sealing the aperture 12 with the sealing cover 400 may be achieved by high-frequency induction heating.

For example, the sealing cover 400 may be thermally sealed to the container 10 by disposing the sealing cover 400 inside a container cap (not shown), closing the cap, and then performing high-frequency induction heating.

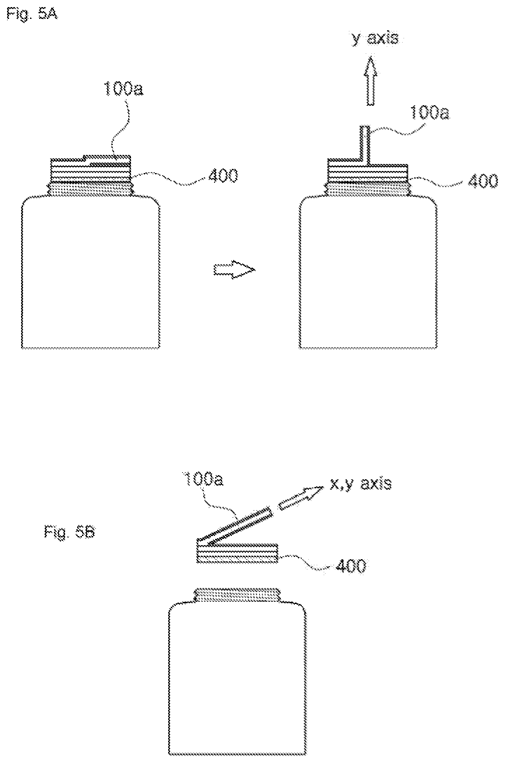

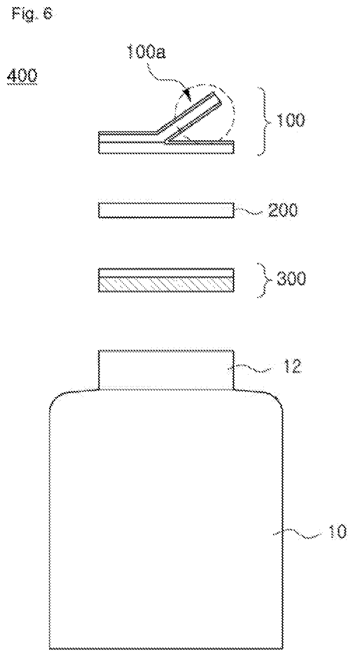

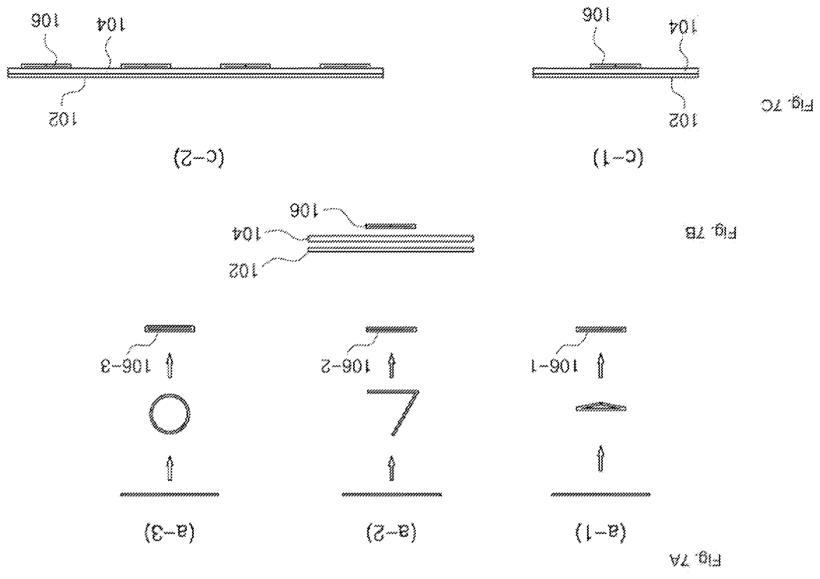

FIGS. 5A and 5B illustrate a method of removing the sealing cover 400 from the container 10.

A user may remove the sealing cover 400 from the aperture 12 and open the container 10 sealed with the sealing cover 400 by pulling up the semi-circular or circular opening tab 100a in the y-axis direction.

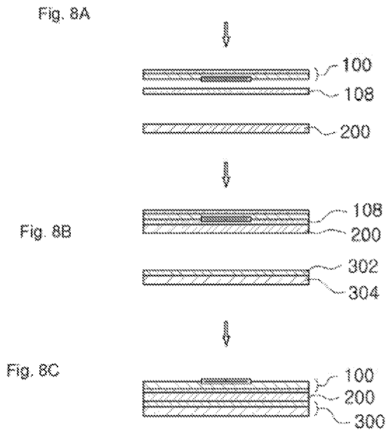

FIG. 6 is a view illustrating a construction of the sealing cover 400 according to an embodiment of the disclosure.

Referring to FIG. 6, the sealing cover 400 according to an embodiment of the disclosure includes three layers, e.g., a tab-forming layer 100, an intermediate substrate layer 200, and a sealing layer 300.

The tab-forming layer 100 includes the opening tab 100a. The intermediate substrate layer 200 may function to ensure close contact between the container 10 and the sealing cover 400 when the cap (not shown) having the sealing cover 400 therein is tightened over the container 10 and to prevent heat generated from an aluminum foil layer by high-frequency induction heating from being transferred to the upper portion of the sealing cover 400. The sealing layer 300 substantially seals the container 10 and isolates contents in the container 10 from the outside.

The tab-forming layer 100 includes a surface layer 102, a first heat-adhesive resin layer 104, a folded film layer 106, and a second heat-adhesive resin layer 108.

The surface layer 102 is formed of a polyethylene terephthalate (PET) or polypropylene (PP) film that has no heat adhesive property. The thickness of the surface layer 102 ranges from 0.012 mm to 0.05 mm. The inner or outer surface of the surface layer 102 can be printed by a gravure method.

The first heat-adhesive resin layer 104 adheres the folded film layer 106 to the surface layer 102.

For example, the first heat-adhesive resin layer 104 may include a polyolefin-based resin, such as polyethylene (PE), ethylene vinyl acetate (EVA), or ethylene acrylic acid (EAA). For example, when the surface layer 102 and the folded film layer 106 are formed of PET films, ethylene-methacrylic acid-acrylate terpolymer resin (e.g., “Nucrel”, which is commercially available from DuPont Inc.) which can strongly adhere to a PET film without conducting a separate chemical primer process, may be used for the first heat-adhesive resin layer 104.

The surface layer 102 and the tab-forming layer 100 may be attached together by extrusion-laminating the first heat-adhesive resin layer 104 therebetween.

The folded film layer 106 is provided to form the opening tab 100a. The folded film layer 106 is formed of a PET or PP film that has no heat adhesive property. The thickness of the folded film layer 106 ranges from 0.012 mm to 0.05 mm. The folded film layer 106 may be formed by folding a band-shaped PET or PP film to have a width ranging from 20 mm to 150 mm.

The width of the folded film layer 106 may be determined depending on, or corresponding to, the diameter of the aperture 12.

The second heat-adhesive resin layer 108 is provided under the folded film layer 106. For example, the second heat-adhesive resin layer 108 adheres to both the lower surface of the folded film layer 106 and the first heat-adhesive resin layer 104.

The second heat-adhesive resin layer 108 may be formed of the same material, e.g., PE, EVA, EMAA, or Nucrel™, as the first heat-adhesive resin layer 104. The surface layer 102 may be formed of the same material, e.g., PET or PP, as the folded film layer 106. Thus, the folded film layer 106 may be strongly adhered to the surface layer 102 via the first heat-adhesive resin layer 104, and the second heat-adhesive resin layer 108 may be strongly adhered to both the folded film layer 106 and the first heat-adhesive resin layer 104. Such material composition of the tab-forming layer 100 enables strong, secure bonding of the layers 102, 104, 106, and 108 and, thus, easy and clean removal of the seal cover from the container without failure, e.g., delamination.

The intermediate substrate layer 200 is interposed between the tab-forming layer 100 and the sealing layer 300. The intermediate substrate layer 200 may provide a close contact and shock absorbing when the cap (not shown) is coupled to the rim of the container that defines the aperture 12 therein. The intermediate substrate layer 200 may prevent heat generated from the aluminum foil layer 302 formed under the sealing cover 400 from being transferred to the upper portion of the sealing cover when high-frequency induction heating adhesion is conducted.

The sealing layer 300 includes the aluminum foil layer 302 and a heat-sealing resin layer 304. The aluminum foil layer 320 may substantially isolate the interior of the container 10 from the outside and generate heat through high-frequency induction heating. The heat-sealing resin layer 304 is provided under the aluminum foil layer 302 and is adhered to the rim that defines the aperture 12 therein by heat generated from the aluminum foil layer 302.

For example, the heat-sealing resin layer 304 may be formed of a film which is produced by a blown film method or by extrusion coating.

Referring to FIG. 6 again, both lower surface of the folded film layer 106 and a portion of the folded film layer 106 that adheres to the surface layer 102 form the opening tab 100a. Such a double structure of the opening tab 100a may increase the tensile strength of the opening tab 100a, thus preventing the opening tab 100a alone from tearing off the sealing cover 400 without removing the whole sealing cover 400 from the container 10 when pulled up.

Meanwhile, the length of the part of the folded film layer 106, which forms the opening tab 100a, and the length of the part of the folded film layer 106, which adheres to the second heat-adhesive resin layer 108, are determined by a position where the folded film layer 106 is cut to form the sealing cover 400. In other words, the position where the folded film layer 106 is cut when the sealing cover 400 is manufactured can be appropriately adjusted such that when the aperture has a relatively small area, both the length of the part that forms the opening tab 100a and the length of the part that adheres to the second heat-adhesive resin layer 108 are sufficiently large and, when the aperture has a relatively large area, the length of the part that forms the opening tab 100a is relatively small while the length of the part that adheres to the second heat-adhesive resin layer 108 is sufficiently large.

FIGS. 7 through 8 are views illustrating a method for manufacturing the sealing cover according to the disclosure.

To form the semi-circular or circular opening tab 100a at the top of the sealing cover 400, as shown in (a-1) of FIG. 7A, a PET or PP film which has no heat adhesive property and has a thickness ranging from 0.012 mm to 0.05 mm and a width ranging from 20 mm to 150 mm may be folded on both sides thereof to form a folded film layer 106-1.

Alternatively, as shown in (a-2) of FIG. 7A, the PET or PP film may be folded in half to form a folded film layer 106-2. As a further alternative, as shown in (a-3) of FIG. 7A, the PET or PP film may be rolled in a cylindrical shape by bonding the opposite edges thereof to each other and may then be pressed to be flat, thus forming a folded film layer 106-3. As used herein, when “A has a heat adhesive property,” A may have an adhesive force when heated, e.g., by high-frequency induction heating, and when “A has no heat adhesive property,” A has no adhesive force although heated. The width of the PET or PP film that is used to form the folded film layer can be appropriately determined depending on the diameter of the aperture of the container.

Thereafter, the surface layer 102, the intermediate substrate layer 200, and the sealing layer 300 are prepared.

Although the above-mentioned folded film layers 106 have different shapes, the final shape thereof becomes the same as that of FIG. 7B, and it is only a matter of whether the folded film layer 106 is cut in a row or two rows when it is cut to have a predetermined size and circular shape in which the product is finally disposed in the cap.

The folded film layer 106 formed by the above-mentioned method adheres to the lower surface of the surface layer 102 that is the uppermost layer of the sealing cover 400. The surface layer 102 is made of a PET or PP film which has no heat adhesive property but has a high tensile strength, and the thickness of which ranges 0.012 mm to 0.05 mm. The surface layer 102 and the folded film layer 106 may be adhered together by an extrusion lamination method in which an adhesive resin is melted and applied therebetween and they are adhered to each other by extruding.

In this embodiment, the first heat-adhesive resin layer 104 has a thickness ranging from 0.015 mm to 0.04 mm, and the first heat-adhesive resin layer 104 may include a polyolefin-based resin, such as polyethylene, ethylene vinyl acetate (EVA), or ethylene acrylic acid (EAA). The first heat-adhesive resin layer 104 may be formed by an extrusion lamination process.

For example, because the surface layer 102 and the folded film layer 106 that is disposed under the first heat-adhesive resin layer 104 are made of PET films, ethylene-methacrylic acid-acrylate terpolymer resin (e.g., “Nucrel”, which is commercially available from DuPont Inc.) which can strongly adhere to a PET film without conducting a separate chemical primer process, may be used for the first heat-adhesive resin layer 104.

In an actual production process, as shown in (c-2) of FIG. 7B, e.g., for the purpose of mass production, several folded film layers 106 may be arranged apart from each other at appropriate intervals and adhere together to the lower surface of the surface layer 102 that is formed of a PET film having a relatively large width.

After the first-step extrusion laminating process using the first heat-adhesive resin layer 104 has been conducted, as shown in FIGS. 8A-8C, the surface layer 102 and the folded film layer 106 that have adhered to each other through the first-step adhesion process adhere to the intermediate substrate layer 200, thus forming a second-step adhesion product.

The intermediate substrate layer 200 is formed of a polyolefin-based film or foam that has a thickness ranging from 0.03 mm to 3 mm.

The adhesion in the second-step adhesion process may be performed by extrusion lamination using the second heat-adhesive resin layer 108 which is made of ethylene-methacrylic acid-acrylate terpolymer resin that is the same material as that of the first heat-adhesive resin layer 104.

The tab-forming layer 100 and the intermediate substrate layer 200 that have been formed through the above-mentioned process adhere to the sealing layer 300 which may substantially seal the container. The sealing layer 300 includes the aluminum foil layer 302 which is disposed in an upper position, and a heat-sealing resin layer 304 which is disposed in a lower position and has an easy peel seal function such that it can be easily sealed to the container 10.

The adhesion between the lower surface of the intermediate substrate layer 200 and the aluminum foil layer 302 of the sealing layer 300 may be performed by a dry lamination method which may be a typical method of adhering plastic films to each other using a solvent-based urethane adhesive, or an extrusion lamination method in which the layers are laminated by melting raw material containing polyethylene, EVA (ethylene vinyl acetate), EMAA (ethylene-methacrylic acid-acrylate), etc. and by extruding the layers with the melted raw material.

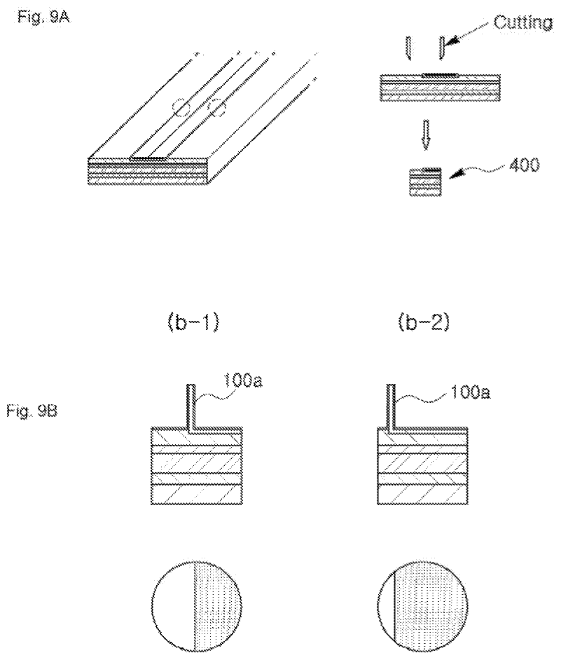

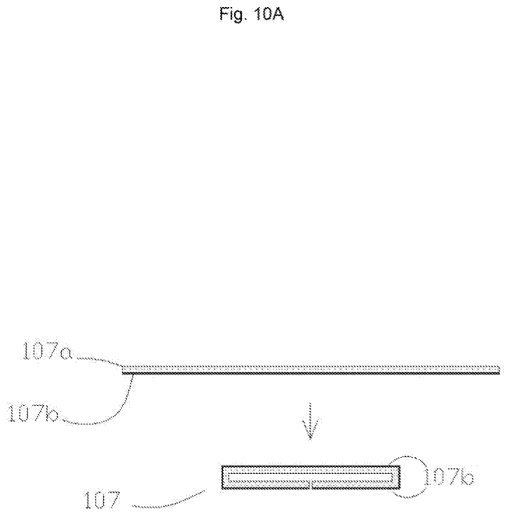

As shown in FIG. 9, the sealing cover 400 is formed in a circular shape corresponding to the size of the cap by cutting or punching the half-finished product manufactured through the above-mentioned process.

FIGS. 9A and 9B are views schematically illustrating a method of cutting out the sealing cover 400 according to the disclosure.

Referring to FIGS. 9A and 9B, the length of the part of the folded film layer 106, which forms the opening tab 100a, and the length of the part of the folded film layer 106, which adheres to the second heat-adhesive resin layer 108, are determined by a position where the folded film layer 106 is cut to form the sealing cover 400.

As shown in (b-1) of FIG. 9B, when the aperture has a relatively large area, the sealing cover 400 is formed such that the length of the part that forms the opening tab 100a is relatively small while the length of the part that adheres to the second heat-adhesive resin layer 108 is sufficiently large.

As shown in (b-2) of FIG. 9, when the aperture has a relatively small area, the sealing cover 400 is formed such that both the length of the part that forms the opening tab 100a and the length of the part that adheres to the second heat-adhesive resin layer 108 are sufficiently large.

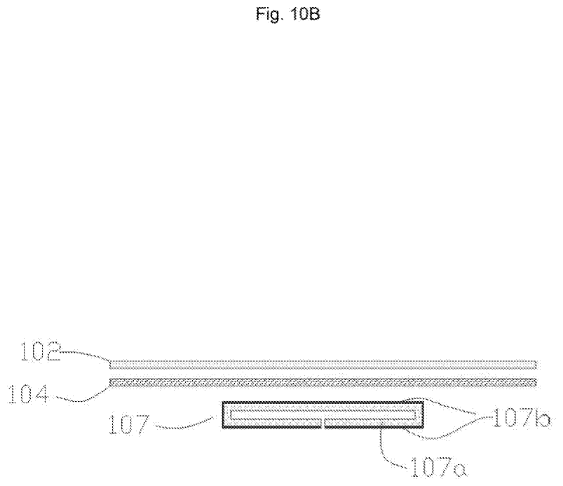

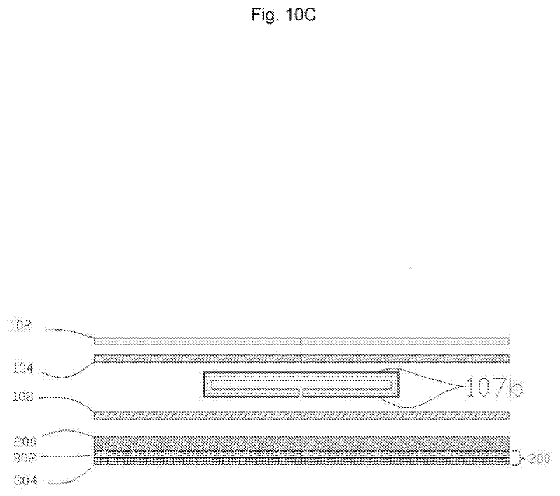

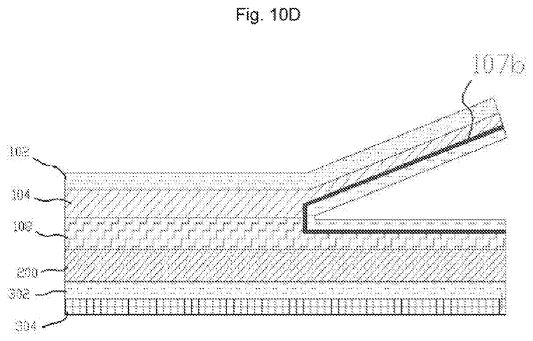

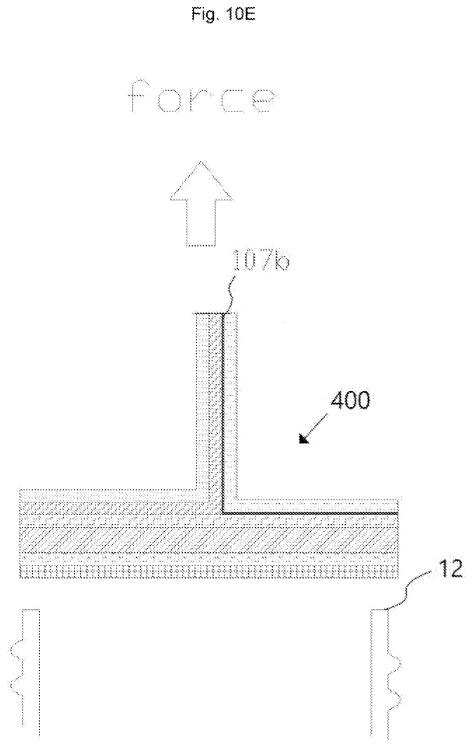

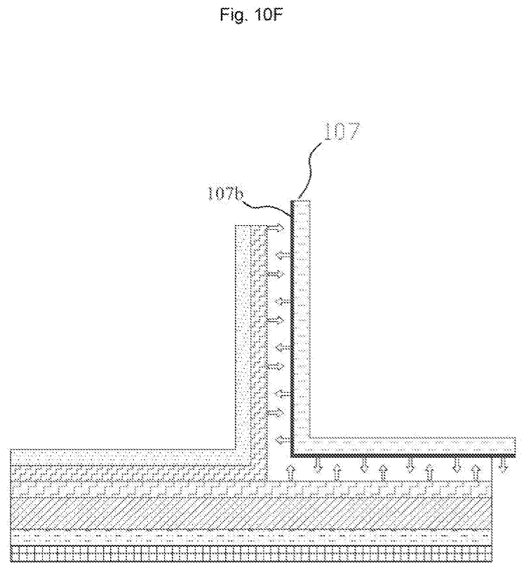

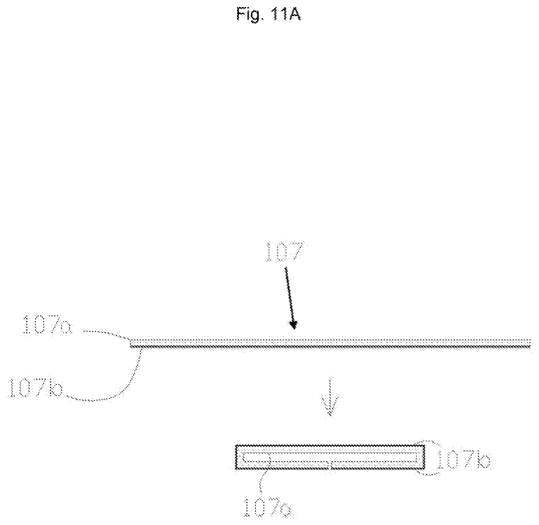

FIG. 10A is a view illustrating a folded film layer included in a sealing cover according to an embodiment of the disclosure.

Referring to FIG. 10A, a folded film layer 107 (e.g., the folded film layer 106) may include a polyester film 107a and a urethane layer 107b coated on the bottom surface of the polyester film 107a. The urethane layer 107b may be 0.001 mm thick or less. The folded film layer 107 may be folded so that the urethane layer 107b faces the outside or is exposed to the outside.

The urethane layer 107b may reinforce the adhesive strength of the folded film layer 107.

In other words, the folded film layer 107 may be more strongly attached to the surface layer 102 via the urethane layer 107b, further reducing the likelihood that the opening tab alone is torn out of the sealing cover upon removing the sealing cover by holding and pulling up the opening tab.

FIG. 10B is a view illustrating an arrangement of a surface layer, a first heat-adhesive resin layer, and a folded film layer included in a sealing cover according to an embodiment.

Referring to FIG. 10B, the first heat-adhesive resin layer 104 is attached to the bottom of the surface layer 102, and the folded film layer 107 is attached to the bottom of the first heat-adhesive resin layer 104. As the folded film layer 107 is folded so that the urethane layer 107b faces the outside, the urethane layer 107b of the folded film layer 107 is attached to the bottom of the first heat-adhesive resin layer 104.

By this configuration, stronger adhesion between the surface 102, which is a polyester film layer, and the urethane layer 107b , may be obtained.

FIG. 10C is a view illustrating an arrangement of a tab-forming layer, an intermediate substrate layer, and a sealing layer included in a sealing cover according to an embodiment of the disclosure.

Referring to FIG. 10C, the second heat-adhesive resin layer 108 is attached to the bottom of the structure of FIG. 10B, specifically, the bottom of the folded film layer 107 and the first heat-adhesive resin layer 104. The intermediate substrate layer 200 is attached to the bottom of the second heat-adhesive resin layer 108, and the sealing layer 300 is attached to the bottom of the intermediate substrate layer 200.

FIG. 10D is a view illustrating a layered structure of a sealing cover according to an embodiment of the disclosure.

FIG. 10D illustrates a sealing cover which includes the tab-forming layer 102, 104, and 107, the intermediate layer 200, and the sealing layer 302 and 304.

The layered structure formed by attaching the layers 102, 104, 107, 108, 200, and 300 together may be cut in the middle thereof, forming the sealing cover as shown in FIG. 10D. The upper and lower pieces of the folded resin layer 107 are seamlessly coupled together at one end of the folded resin layer 107, with the upper and lower pieces separated from each other at the other end of the folded resin layer 107. The opening tab may be pulled up.

FIG. 10E is a view illustrating an example operation of a sealing cover according to an embodiment of the disclosure.

Referring to FIG. 10E, the sealing cover 400 which used to have been attached to the aperture 12 of the container 20 may be removed from the aperture 12 of the container 20 by holding and pulling up the opening tab.

As such, when the user holds and pulls up the opening tab, the overall seal cover may be removed from the container without failure—i.e., the delamination issue that the opening tab alone tears off the seal cover, with the underneath layers still left on the mouth of the container, may be addressed.

FIG. 10F is a view illustrating how attaching force works between the folded film layer and the layers on the side and bottom of the folded film layer upon pulling the opening tab upwards as shown in FIG. 10E. The attaching force is denoted with arrows.

It may be identified from FIG. 10F that the attaching force evenly works over the entire opening tab, providing prominent effects over the prior art thanks to the attaching force of the upright portion.

As such, the urethane layer (107b)-coated folded film layer 107 may be more strongly attached to the first heat-adhesive resin layer 104 and the second heat-adhesive resin layer 108 than when the folded film layer 107 lacks the urethane layer 107b.

Major reasons for coating the polyester folded film layer 107 with the urethane layer 107b are as follows.

The first heat-adhesive resin layer 104 and the second heat-adhesive resin layer 108 are formed of a special (or, high-cost) adhesive, such as EMAA or EVA, to provide strong adhesivity to a regular polyester film.

However, if the folded film layer 107 is coated with the urethane layer 107b, the first heat-adhesive resin layer 104 and the second heat-adhesive resin layer 108 may be formed of a low-cost heat adhesive resin, e.g., polyethylene (e.g., low-density polyethylene (LDPE)), which is commonly used in extrusion laminating because the polyethylene first heat-adhesive resin layer 104 and the polyethylene second heat-adhesive resin layer 108 may be well attached strongly to the polyester folded film layer 107 via the urethane layer 107b. Thus, cost savings may be achieved. Further, better or stronger adhesivity may be achieved when the first heat-adhesive resin layer 104 and the second heat-adhesive resin layer 108, which are formed of polyethylene, are attached to the urethane layer-coated folded film layer 107 than when the first heat-adhesive resin layer 104 and the second heat-adhesive resin layer 108, which are formed of EMAA or EVA, are attached to the urethane layer-free folded film layer 107.

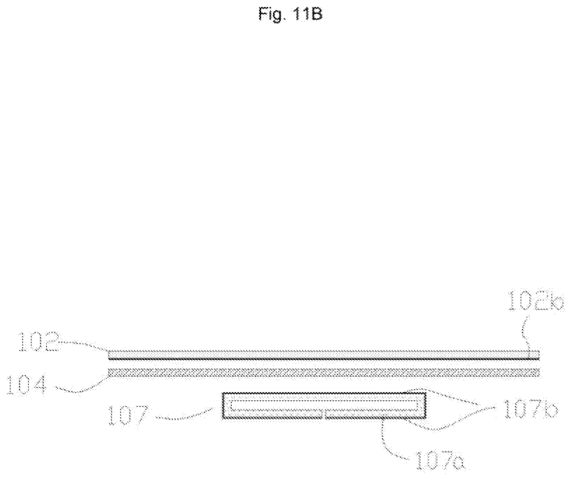

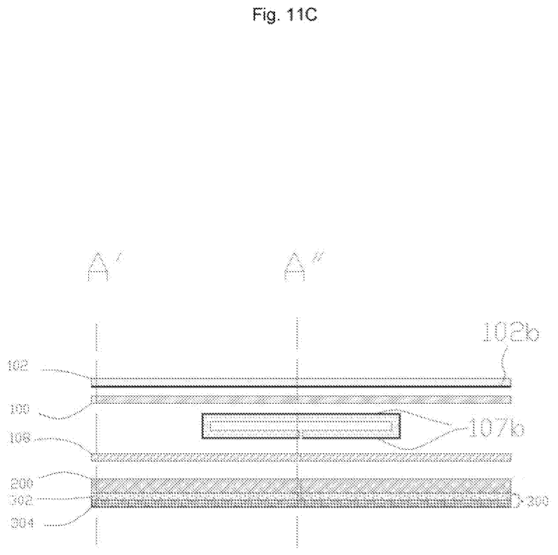

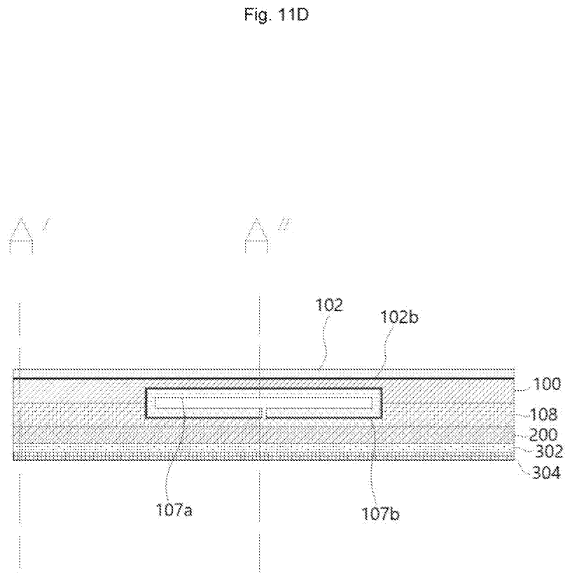

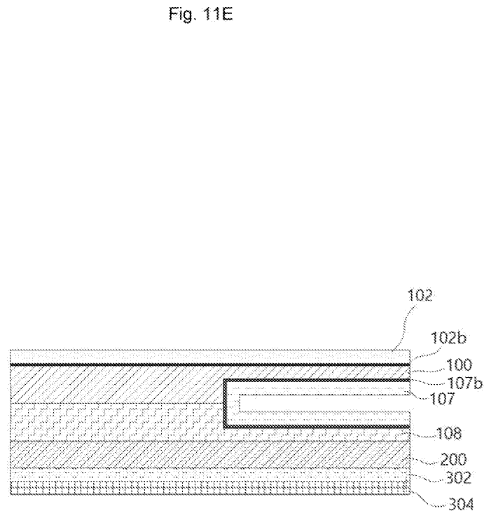

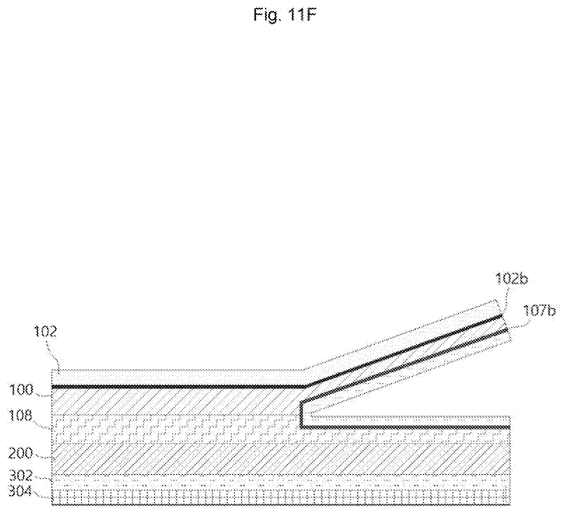

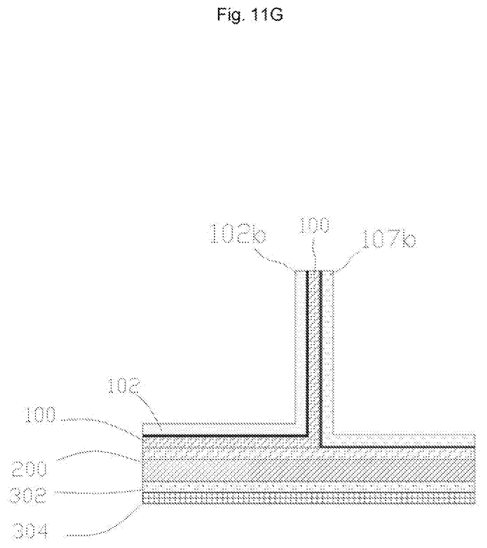

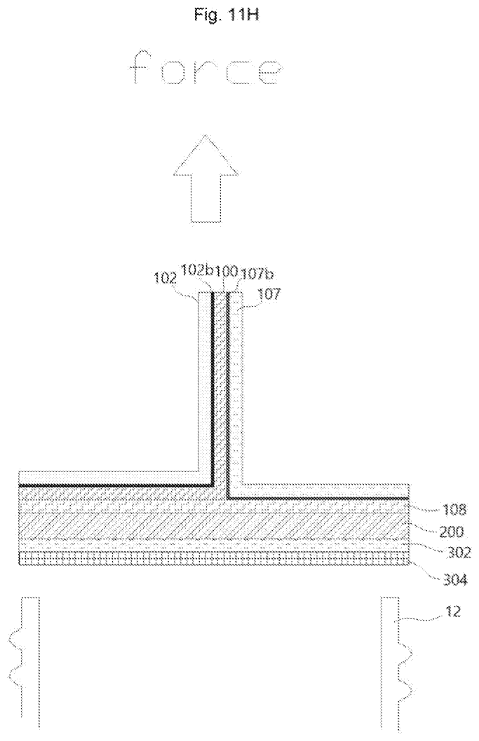

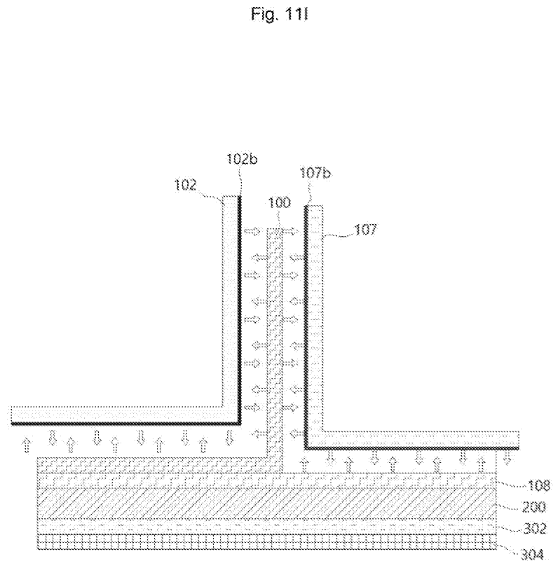

FIG. 11A is a view illustrating a folded film layer included in a sealing cover according to an embodiment of the disclosure.

Referring to FIG. 11A, a folded film layer 107 (e.g., the folded film layer 106) may include a polyester film 107a and a urethane layer 107b coated on the bottom surface of the polyester film 107a. The urethane layer 107b may be 0.001 mm thick or less. The folded film layer 107 may be folded so that the urethane layer 107b faces the outside or is exposed to the outside. Substantially the same method as that used in the embodiment described above in connection with FIGS. 10A to 10F may be applied.

The urethane layer 107b may reinforce the adhesive strength of the folded film layer 107.

In other words, the folded film layer 107 may be more strongly attached to the surface layer 102 via the urethane layer 107b, further reducing the likelihood that the opening tab alone is torn out of the sealing cover upon removing the sealing cover by holding and pulling up the opening tab.

FIG. 11B is a view illustrating an arrangement of a surface layer, a first heat-adhesive resin layer, and a folded film layer included in a sealing cover according to an embodiment.

Referring to FIG. 11B, the first heat-adhesive resin layer 104 is attached to one surface of the urethane layer (107b)-coated folded film layer 107.

A urethane layer 102b is formed on the bottom of the surface layer 102.

Thus, the urethane layer 102b on the bottom of the polyester surface layer 102, along with the first heat-adhesive resin layer 104, may be strongly attached to the urethane layer 107b of the polyester folded film layer 107.

FIGS. 11C and 11D are views illustrating an example of arranging and attaching together a tab-forming layer, an intermediate substrate layer, and a sealing layer included in a sealing cover according to an embodiment of the disclosure.

Referring to FIGS. 11C and 11D, the second heat-adhesive resin layer 108 is attached onto the bottom of the layered structure of FIG. 11B, and the intermediate substrate layer 200 and the sealing layer 300 (i.e., the aluminum foil layer 302 and the heat-sealing resin layer 304) are sequentially attached onto the bottom of the second heat-adhesive resin layer 108.

FIGS. 11E, 11F, and 11G are views illustrating an example of gradually lifting up the opening tab formed by cutting the layered structure of FIG. 11D off, at the middle thereof.

FIG. 11H is a view illustrating an example of pulling up the sealing cover 400 attached to the mouth of the container.

FIG. 11I is a view illustrating the attaching force applied to the opening tab when the sealing cover is pulled up from the container. The attaching force is denoted with arrows. It may be identified from FIG. 11I that much more attaching force may be obtained than the embodiment described above with FIGS. 10A to 10F, not alone the prior art.

Substantially the same, or much better, effects as those described with reference to FIGS. 10A to 10F may be achieved by the embodiment described above with reference to FIGS. 11A to 11I.

The first heat-adhesive resin layer 104 and the second heat-adhesive resin layer 108 are formed of a special (or, high-cost) adhesive, such as EMAA or EVA, to provide strong adhesivity to a regular polyester film.

However, if the folded film layer 107 is coated with the urethane layer 107b, the first heat-adhesive resin layer 104 and the second heat-adhesive resin layer 108 may be formed of a low-cost heat adhesive resin, e.g., polyethylene (e.g., low-density polyethylene (LDPE)), which is commonly used in extrusion laminating because the polyethylene first heat-adhesive resin layer 104 and the polyethylene second heat-adhesive resin layer 108 may be well attached more strongly to the polyester folded film layer 107 via the urethane layer 107b. Thus, cost savings may be achieved. Further, better or stronger adhesivity may be achieved when the first heat-adhesive resin layer 104 and the second heat-adhesive resin layer 108, which are formed of polyethylene, are attached to the urethane layer-coated folded film layer 107 than when the first heat-adhesive resin layer 104 and the second heat-adhesive resin layer 108, which are formed of EMAA or EVA, are attached to the urethane layer-free folded film layer 107.

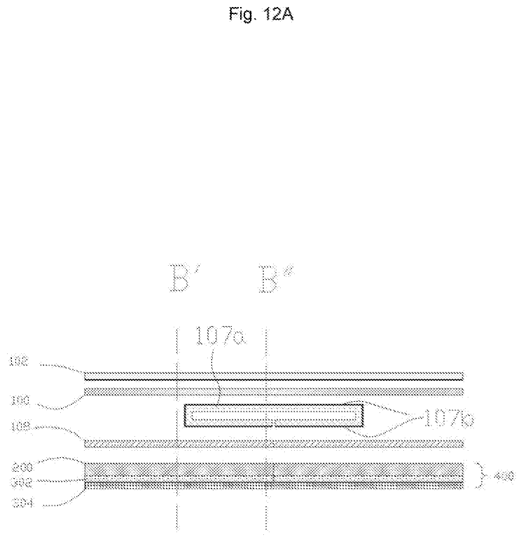

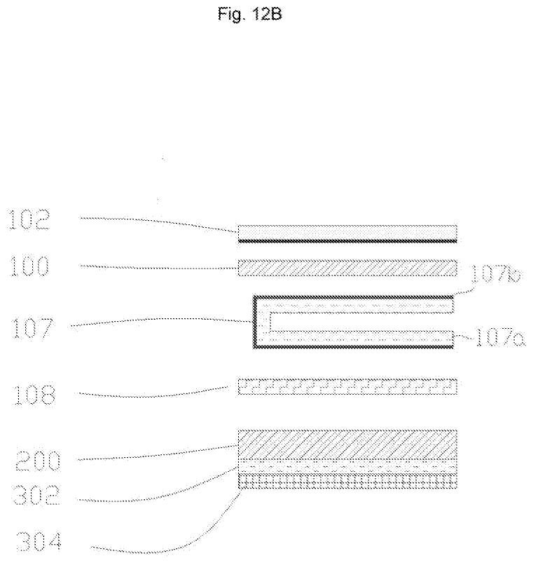

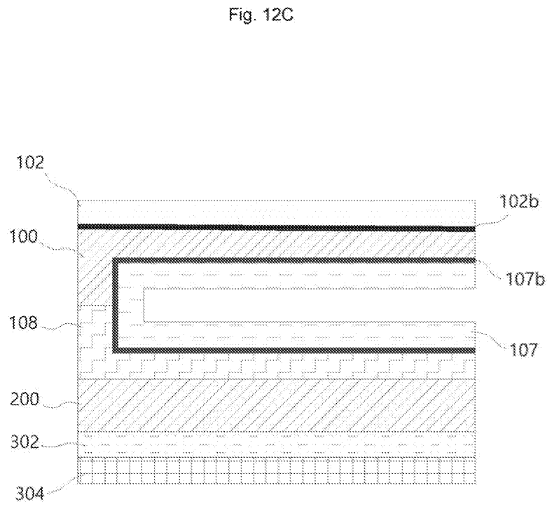

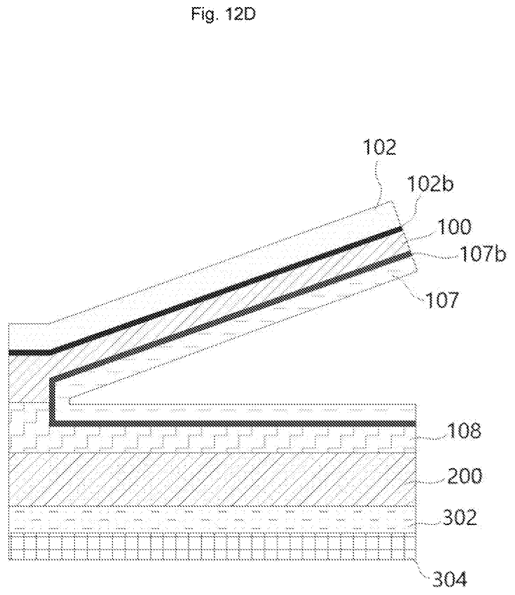

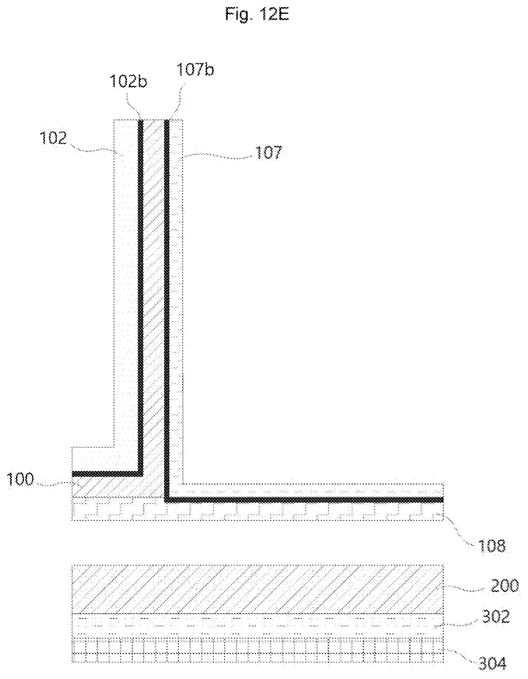

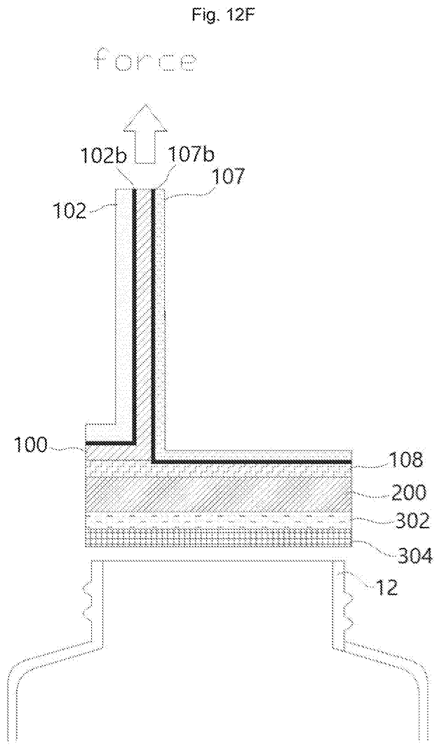

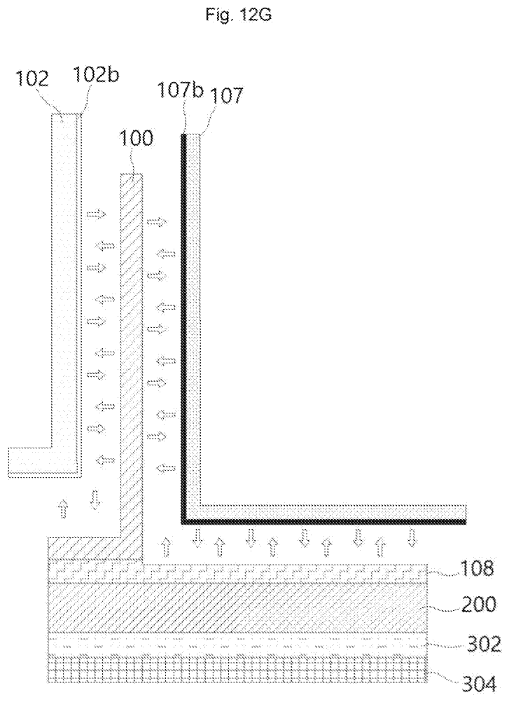

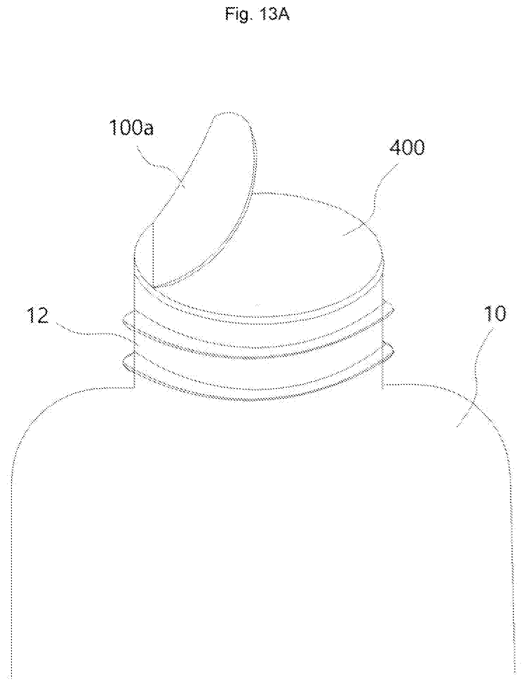

FIGS. 12A, 12B, and 12C are views illustrating a process for manufacturing an opening tab by cutting a layered structure for a sealing cover, along lines denoted with B′ and B″, according to an embodiment of the disclosure.

FIGS. 12D and 12E are views illustrating an example in which the opening tab formed as shown in FIG. 12C is gradually lifted up.

FIG. 12F is a view illustrating an example in which the sealing cover attached to the container is pulled up and removed from the container by applying force.

FIG. 12G is a view illustrating attaching force works in directions denoted with arrows between the components (e.g., 102, 100, 107, and 108) when the opening tab is pulled up from the container.

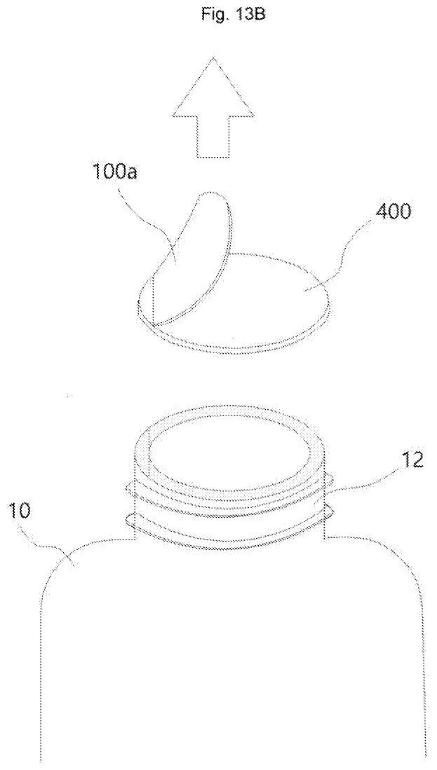

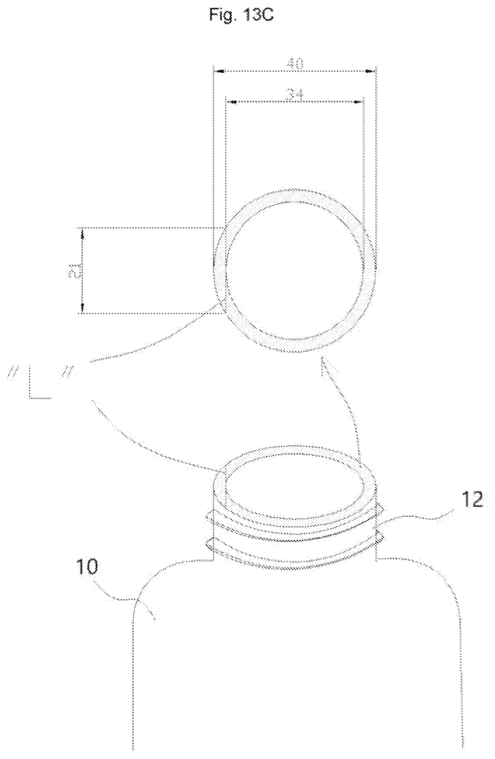

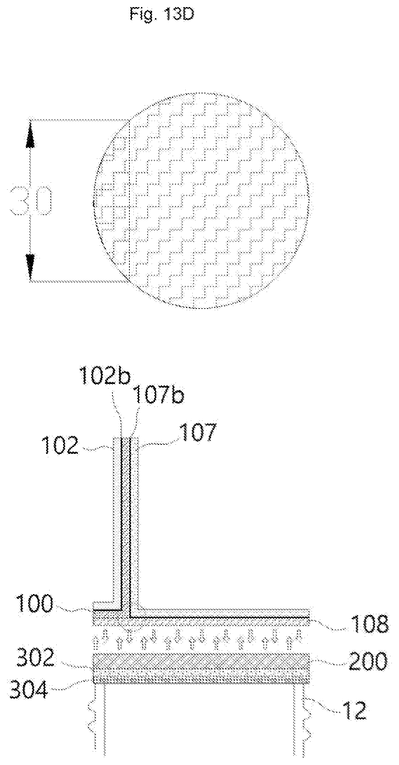

FIG. 13A is a perspective view illustrating an example in which a sealing cover is attached to a container according to an embodiment of the disclosure.

FIG. 13B is a perspective view illustrating an example in which the sealing cover of FIG. 13A is removed from the container by pulling up with the opening tab.

FIG. 13C illustrates the mouth of the container of FIG. 13A or 13B.

FIG. 13D illustrates attaching force working in directions denoted with arrows between some components (e.g., 108 and 200) of a sealing cover according to an embodiment of the disclosure.

Referring to FIGS. 12A to 13D, the effects achieved by an embodiment of the disclosure are described below.

The inter-film bond strength may refer to a force value at which two films are attached together and may be typically measured by a tensile tester based on peel strength which is the force value at which two bonded samples are detached from each other when pulled away from each other in opposite directions.

The inter-film bond strength for packing materials is typically 600 gf/15 mm which means the force measured at the moment of peel-off according to the length of the bonded films (although it may be measured according to the area of the bonded films, the peel strength along the length is widely adopted internationally), and the peel strength typically ranges from 500 gf/15 mm to 1,500 gf/15 mm. For illustration purposes, the mean peel strength, e.g., 1,000 gf/15 mm, is used in the following description.

The sealing cover cut to have a circular shape, with the portion of the opening tab 102 larger in area than the rest thereof, is attached to the mouth 12 of the container 10 as shown in FIG. 13A. When pulled up with the opening tab 102 gripped, the sealing cover is removed from the container 10 as shown in FIG. 13B.

In this case when the mouth 12 of the container 10 has an outer diameter of 40 mm and an inner diameter of 34 mm as shown in FIG. 13C, the sealing cover starts to detach off from one side thereof, with the most force applied along line “L”. The length of line “L” is 21 mm as shown in FIG. 13C, and thus, a peel strength of 1,400 gf/21 mm may be needed to peel the sealing cover off, based on the typical peel strength of 1,000 gf/15 mm as described above.

The inter-film bond strength for packing materials is typically 600 gf/15 mm as described above. Thus, when the opening tab 102 is positioned at a side the distance of two ends of which is 30 mm as shown in FIG. 13D, the inter-film bond strength is 1,200 gf/30 mm. In the structure according to embodiments of the disclosure, since the surface layer and the folded film layer are attached at two sides as shown in FIG. 12G, a two times higher bond strength, i.e., 2,400 gf/30 mm (1680 gf/21 mm), may always be provided than the typical inter-film bond strength, i.e., 1,200 gf/30 mm, and this is much higher than the peel strength of 1,400 gf/21 mm, and thus, the sealing cover may be removed from the container in an easy and opening tab tear-free manner.

In other words, even when the opening tab is formed to be positioned away from the center and closer to a side as shown in FIGS. 12A to 12F, the opening tab may be prevented from being broken before the entire sealing cover is removed from the mouth of the container as the opening tab is formed to be positioned at the center.

Unlike the conventional sealing cover having the semi-circular opening tab, in the sealing cover according to the disclosure, the opening tab which is provided at the top of the sealing cover may have a semi-circular shape or a substantially circular shape, Therefore, a consumer can more conveniently and easily open the container.

Furthermore, because the layers that form the opening tab in the sealing cover adhere to each other in the entire area thereof, delamination in which only the opening tab is removed from the sealing cover when the container is opened may be prevented. Therefore, the container sealing cover has a more reliable structure.

Although the container sealing cover having the opening tab and the method for manufacturing the sealing cover according to the embodiment of the disclosure have been disclosed for illustrative purposes, those skilled in the art will appreciate that various modifications, additions and substitutions are possible, without departing from the scope and spirit of the invention as disclosed in the accompanying claims.

What is claimed is:

1. A sealing cover, comprising:
a tab-forming layer, the tab-forming layer including:
a surface layer;
a first adhesive layer under the surface layer;
a folded layer under the first adhesive layer; and
a second adhesive layer under the first adhesive layer and the folded layer;
an intermediate substrate layer under the tab-forming layer; and
a sealing layer under the intermediate substrate layer, wherein the folded layer includes an upper portion and a lower portion branched from one end of the folded layer.

2. The sealing cover of claim 1, wherein the surface layer is formed of polyethylene terephthalate (PET) or polypropylene (PP).

3. The sealing cover of claim 2, wherein the folded layer is formed of substantially the same material as the surface layer.

4. The sealing cover of claim 3, wherein the first adhesive layer is formed of polyethylene (PE), ethylene vinyl acetate (EVA), ethylene acrylic acid (EAA), or ethylene-methacrylic acid-acrylate terpolymer.

5. The sealing cover of claim 4, wherein the second adhesive layer is formed of substantially the same material as the first adhesive layer.

6. The sealing cover of claim 1, wherein the sealing layer includes an aluminum foil layer and a heat-sealing resin layer under the aluminum foil layer.

7. The sealing cover of claim 6, wherein a thickness of the aluminum foil layer ranges from 0.009 mm to 0.05 mm.

8. The sealing cover of claim 6, wherein a thickness of the heat-sealing resin layer ranges from 0.03 mm to 0.1 mm.

9. The sealing cover of claim 6, wherein the intermediate substrate layer and the aluminum foil layer are adhered to each other via a solvent-based urethane adhesive, polyethylene, EVA, or EMAA.

10. The sealing cover of claim 1, wherein the surface layer has a thickness ranging from 0.012 mm to 0.05 mm, and the folded layer has a thickness ranging from 0.012 mm to 0.05 mm, and wherein the folded film layer has a folded band shape.

11. The sealing cover of claim 1, wherein the folded layer is cut into a size capable of being inserted into a cap of a container, and wherein the upper portion and lower portion of the folded layer face each other, with a gap formed therebetween.

12. The sealing cover of claim 1, wherein the folded layer includes a folded PE film and a folded urethane layer surrounding the PE film, and wherein the urethane layer of the folded layer is attached to the first adhesive layer and the second adhesive layer.

13. The sealing cover of claim 12, wherein the folded layer is folded substantially in a shape of “<.”

14. The sealing cover of claim 11, wherein when the container is a bottle, the sealing cover is sized or shaped to correspond to a mouth of the bottle.

15. The sealing cover of claim 1, wherein the surface layer and the folded layer are formed of substantially the same material, and the first adhesive layer and the second adhesive layer are formed of substantially the same material but different from, but strongly bonded to, the surface layer and the folded layer.

16. The sealing cover of claim 13, wherein another urethane layer is formed on a bottom surface of the surface layer.
